(19) United States
(12) Patent Application Publication
(10) Pub. No.: US 2026/0040202 A1
(43) Pub. Date: Feb. 5, 2026

(54) PROACTIVELY MOVING USER EQUIPMENT TO PREFERRED CELLGROUPS

(71) Applicant: T-Mobile USA, Inc., Bellevue, WA (US)

(72) Inventors: Reman Pezhumkad BALAKRISHNA, Nutley, NJ (US); David LEE-CHIN, Overland Park, KS (US)

(21) Appl. No.: 18/791,416

(22) Filed: Jul. 31, 2024

(51) Int. Cl. H04W 48/20; H04W 48/04

(52) U.S. Cl. CPC H04W 48/20; H04W 48/04

(57) ABSTRACT

Proactively moving user equipment (UEs) to preferred cellgroups (preferred cellular generation and frequency layer) improves user experience by triggering steering actions (handovers) for long duration connection devices, such as WiFi access points using cellular connections that remain stationary, even when the UEs do not report conditions that traditionally warrant steering actions. This addresses the scenario in which a stationary use cellular UE, such as a fixed wireless access (FWA) unit that is commonly used as a home WiFi router, is moved from a high bandwidth cell to a lower bandwidth cell as a result of an outage of the high bandwidth cell, but does not report any condition that would trigger a steering action back to the high bandwidth cell when the high bandwidth cell becomes available again. The preferred cellgroups may be UE-specific, and based on factors such as network loading, UE capability, and subscriber data.

### BACKGROUND

Cellular networks comply with Third Generation Partnership Project (3GPP) technical standards (TSs) that proscribe approaches for triggering steering actions (e.g., handovers or redirections) for user equipment (UEs), and which move UEs from one cell to another cell. These approaches rely on a UE to identify certain conditions, such as an A3 condition (a neighbor cell is better than the serving cell by some margin) or an A5 condition (the serving cell is worse than a first threshold and a neighbor cell is better than a second threshold). Upon identification of an A3 condition or an A5 condition by a UE, the network will initiate a steering action for the UE.

With the rising popularity of using some cellular UEs as facility internet access points, such as a fixed wireless access (FWA) unit providing WiFi router functionality with connection to the internet over a cellular connection, the stationary use case (i.e., in contrast to a mobile handset that moves frequently among different cells) results in long duration connections. This introduces the possibility of a suboptimal user experience in some scenarios.

For example, an FWA may be on a high frequency layer (e.g., n41) on a higher bandwidth cellular generation cell, that provides high bandwidth and favorable throughput, at a time at which the high frequency layer experiences an outage. The FWA is then handed over to a lower frequency layer (e.g., n71), or an older cellular generation cell, that provides less bandwidth and lower throughput. This is acceptable to preserve connectivity to the internet—at least temporarily. When the high frequency layer recovers from the outage, however, if the A3 condition or A5 condition is not met, because the lower frequency layer provides a higher received power than the high frequency layer, the FWA will remain on the lower frequency layer (or older cellular generation cell), continuing to experience the lower throughput.

### SUMMARY

The following summary is provided to illustrate examples disclosed herein, but is not meant to limit all examples to any particular configuration or sequence of operations.

Solutions are disclosed that provide for proactively moving user equipment (UEs) to preferred cellgroups (i.e., a preferred radio access technology (RAT), a preferred frequency layer or set of carrier aggregation (CA) frequency layers, and/or a preferred public land mobile network (PLMN) such as a home network). Examples determine, by a wireless network, based on at least determining a first mobility profile for a first UE, a first preferred cellgroup for the first UE; upon a trigger event: monitor whether the first UE is using the first preferred cellgroup; and monitor whether a frequency layer in the first preferred cellgroup is available for a steering action of the first UE, wherein the steering action comprises a handover or a redirection of the first UE to an available frequency layer of the first preferred cellgroup; and based on at least the first UE not using the first preferred cellgroup and based on at least the available frequency layer of the first preferred cellgroup becoming available, and without any steering action request by the first UE, instruct the first UE, by the wireless network, to perform the steering action.

### BRIEF DESCRIPTION OF THE DRAWINGS

The disclosed examples are described below with reference to the accompanying drawing figures listed below, wherein:

FIG. 1 illustrates an exemplary architecture that advantageously moves user equipment (UEs) to preferred cellgroups, proactively;

FIG. 2 illustrates a workflow associated with examples of the architecture of FIG. 1, and further detail for the architecture of FIG. 1;

FIG. 3 illustrates a flowchart of exemplary operations associated with the architecture of FIG. 1;

FIG. 4 illustrates a roaming scenario that may occur when using examples of the architecture of FIG. 1;

FIG. 5 illustrates a timeline of exemplary events associated with the architecture of FIG. 1;

FIGS. 6 and 7 illustrate additional flowcharts of exemplary operations associated with the architecture of FIG. 1; and

FIG. 8 illustrates a block diagram of a computing device suitable for implementing various aspects of the disclosure.

Corresponding reference characters indicate corresponding parts throughout the drawings. References made throughout this disclosure. relating to specific examples, are provided for illustrative purposes, and are not meant to limit all implementations or to be interpreted as excluding the existence of additional implementations that also incorporate the recited features.

### DETAILED DESCRIPTION

Proactively moving user equipment (UEs) to preferred cellgroups (preferred cellular generation and frequency layer) improves user experience by triggering steering actions (handovers) for long duration connection devices, such as WiFi access points using cellular connections that remain stationary, even when the UEs do not report conditions that traditionally warrant steering actions. This addresses the scenario in which a stationary use cellular UE, such as a fixed wireless access (FWA) unit that is commonly used as a home WiFi router, is moved from a high bandwidth cell to a lower bandwidth cell as a result of an outage of the high bandwidth cell, but does not report any condition that would trigger a steering action back to the high bandwidth cell when the high bandwidth cell becomes available again. The preferred cellgroups may be UE-specific, and based on factors such as network loading, UE capability, and subscriber data.

Aspects of the disclosure improve the performance of providing wireless services, by enabling a wireless network to proactively move stationary use UEs (such as facility WiFi access points) to preferred connections such a higher bandwidth cells, even when the UEs do not report conditions warranting a steering action. These advantageous results are accomplished, at least in part, by based on at least a UE not using a preferred cellgroup and based on at least an available frequency layer of the preferred cellgroup becoming available, and without any steering action request by the UE, instructing the UE, by a wireless network, to perform a steering action.

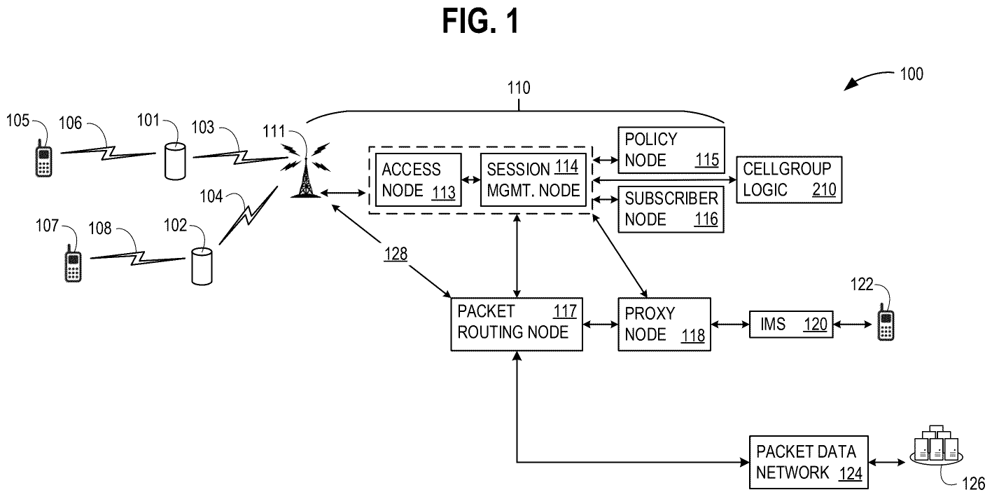

With reference now to the figures, FIG. 1 illustrates an exemplary architecture 100 that advantageously provides for proactively moving UEs to preferred cellgroups. As used herein, a cellgroup is a defined combination of a radio access technology (RAT, or cellular generation), a frequency layer or set of carrier aggregation (CA) frequency layers, and a public land mobile network (PLMN, or cellular network).

A wireless network 110 is illustrated that is serving a UE 101 and a UE 102. Each of UE 101 and UE 102 may be a fixed wireless access (FWA), such as a home (or other facility) internet access point, that is associated with a stationary use. An example may be a WiFi router that reaches the internet using cellular network (e.g., wireless network 110). In contrast, a handset UE, such as enhanced mobile broadband (eMBB) or cellphone, is not associated with a stationary use-even a cellular telephone that provides a mobile internet access hotspot, because the dominant use cases for cellular telephones include a high degree of mobility and stationary use is determined by UE device type (e.g., FWA versus eMBB).

In the scene depicted in FIG. 1, UE 101 is providing a short range wireless interface 106 (e.g., WiFi) to a UE 105 and UE 102 is providing a short range wireless interface 108 to a UE 107. Each of UE 105 and UE 107 may be an eMBB or cellphone, an internet of things (IoT) device, machine-to-machine (M2M) communication device, or a personal computer (PC, e.g., desktop, notebook, tablet, etc.), or another telecommunication devices capable of using short range wireless interface 106 or 108. In the scene depicted in FIG. 1, UE 105 is using wireless network 110 (via UE 101) for a packet data session to reach a network resource 126 (e.g., a website) across an external packet data network 124 (e.g., the internet). In some scenarios, UE 105 may use wireless network 110 for a phone call with another UE 122 (a WiFi call, at least to UE 101). Wireless network 110 may be a cellular network such as a fifth generation (5G) network, a fourth generation (4G) network, or another cellular generation network. In some contexts, 5G is also referred to as new radio (NR), and standalone 5G, which is a full 5G implementation that does not rely on 4G technology for some functionality, may be referred to SA NR.

UE 101 uses an air interface 103 to communicate with a base station 111 of wireless network 110, such that base station 111 is the serving base station for UE 101 (providing the serving cell), and UE 102 uses an air interface 104 to communicate with a base station 111. In some scenarios, base station 111 may be referred to as a radio access network (RAN). Wireless network 110 has an access node 113, a session management node 114, a policy node 115, a subscriber node 116, and other components (not shown). Wireless network 110 also has a packet routing node 117 and a proxy node 118. Access node 113, session management node 114, policy node 115, and subscriber node 116 are within a control plane of wireless network 110, and packet routing node 117 is within a data plane (a.k.a. user plane) of wireless network 110.

Base station 111 is in communication with access node 113 and packet routing node 117. Access node 113 is in communication with session management node 114, which is in communication with policy node 115, a subscriber node 116, packet routing node 117, and proxy node 118. Packet routing node 117 is in communication with proxy node 118 and packet data network 124. In some 5G examples, base station 111 comprises a gNodeB (gNB), access node 113 comprises an access mobility function (AMF), session management node 114 comprises a session management function (SMF), policy node 115 comprises a policy control function (PCF), subscriber node 116 comprises a unified data management (UDM), and packet routing node 117 comprises a user plane function (UPF). In some 4G examples, base station 111 comprises an eNodeB (eNB), access node 113 comprises a mobility management entity (MME), session management node 114 comprises a system architecture evolution gateway (SAEGW) control plane (SAEGW-C), policy node 115 comprises a policy and charging rules function (PCRF), subscriber node 116 comprises a home subscriber server (HSS), and packet routing node 117 comprises an SAEGW-user plane (SAEGW-U). In some examples, proxy node 118 comprises a proxy call session control function (P-CSCF) in both 4G and 5G.

In some examples, wireless network 110 has multiple ones of each of the components illustrated, in addition to other components and other connectivity among the illustrated components. In some examples, wireless network 110 has components of multiple cellular technologies operating in parallel in order to provide service to UEs of different cellular generations. For example, wireless network 110 may use both a gNB and an eNB co-located at a common cell site. In some examples, multiple cells may be co-located at a common cell site, and may be a mix of 5G and 4G.

Proxy node 118 is in communication with an internet protocol (IP) multimedia system (IMS) 120, which uses an access gateway (IMS-AGW) in order to provide connectivity to other wireless (cellular) networks, such as for a call with a UE 122 or a public switched telephone system (PSTN, also known as plain old telephone system, POTS). In some examples, proxy node 118 may be considered to be within IMS 120. UE 101 reaches network resource 126 using packet data network 124 (or IMS 120, in some examples). Data packets of data traffic 128 to/from UE 101 pass through at least base station 111 and packet routing node 117 on their way from/to packet data network 124 or IMS 120 (via proxy node 118).

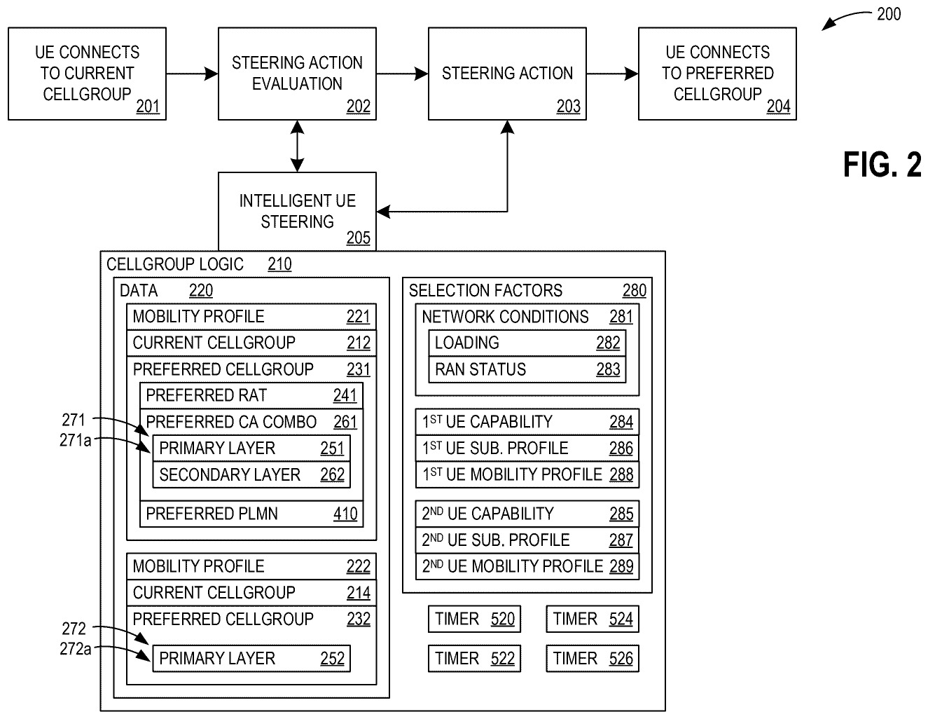

As illustrated in further detail in FIG. 2 the other remaining figures, and described more fully below in relation to the other figures, wireless network 110 has a preferred cellgroup logic 210 that determines a preferred cellgroup 231 for UE 101 and a preferred cellgroup 232 for UE 102. Preferred cellgroup logic 210 then proactively moves UE 101 to preferred cellgroup 231, when preferred cellgroup 231 is available to UE 101, and proactively moves UE 102 to preferred cellgroup 232, when preferred cellgroup 232 is available to UE 102. (See FIG. 2.) This prevents the unfavorable scenario in which UE 101 and/or UE 102 has a long duration connection to a less favorable frequency layer, degrading the user experience for the users of UE 101 and UE 102.

Although FIG. 1 and some of the following figures are described using an example of a cellular network, it should be understood that the teachings herein are applicable to other types of wireless networks. To benefit from the teachings herein, another wireless network, other than a cellular network, should offer radio sites with overlapping coverage and differing throughput, as well as have provisions for monitoring which radio sites are available for use by a UE and triggering steering actions for the UEs. With such features, another type of wireless network, other than a cellular network, may also benefit from the disclosure herein.

FIG. 2 illustrates a workflow 200 associated with examples of architecture 100, and further detail for preferred cellgroup logic 210. At stage 201 of workflow 200, UE 101 connects to a nonpreferred cellgroup (i.e., not preferred cellgroup 231) as a current cellgroup 212. Stage 202 performs steering action evaluation (initially), and a steering action is possible at stage 203, if a better radio signal quality is found. This may result in UE 101 connecting to preferred cellgroup 231 at stage 204. In some examples, a cellgroup may include dual connectivity (DC), in which a configured set of serving cells for a UE includes a master cell group (MCG) containing serving cells of the Master Node (MN) and a secondary cell group (SCG) containing serving cells of the secondary node (SN). In some examples, a cellgroup may include multi-radio DC (MRDC), in which different RATs are used simultaneously (i.e., one by the primary cell, PCell, and the other by the secondary cell, SCell), such as 4G in MCG and 5G in SCG or vice versa.

A stage 205 is shown as intelligent UE steering, in which preferred cellgroup logic 210 proactively steers UE 101 to preferred cellgroup 231, if UE 101 had not already moved to preferred cellgroup 231 as a result of the initial steering action evaluation of early stage 2. That is, stage 4 of workflow 200 uses an ongoing version of stage 202 steering action evaluation to guide steering action in stage 203 into moving UE 101 to preferred cellgroup 231 at stage 204. Once UE 101 is moved to preferred cellgroup 231, workflow 200 concludes.

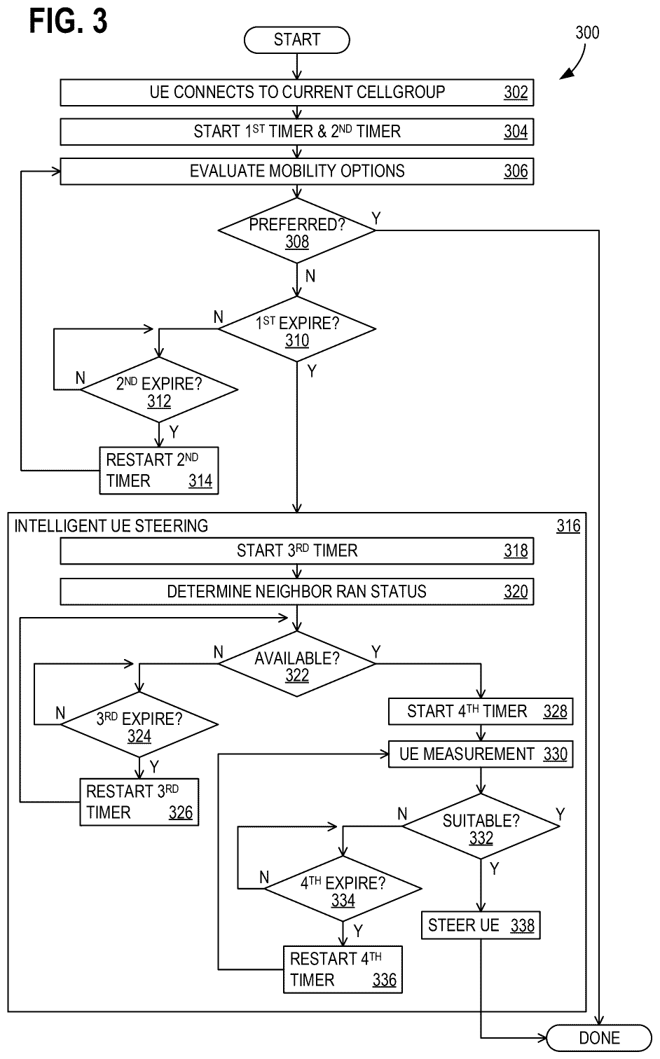

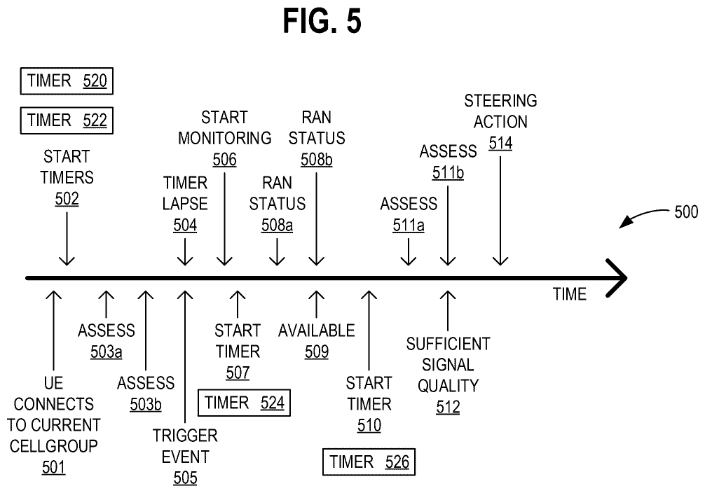

Workflow 200 uses preferred cellgroup logic 210, which is shown as having data sets 220, cellgroup selection factors 280, and four timers (a timer 520, a timer 522, a timer 524, and a timer 526), which are described in further detail in relation to FIGS. 3 and 5. Data sets 220 pulls information for UE 101 and UE 102 from policy node 115 and subscriber node 116. For example, a mobility profile 221 for UE 101 has information related to the type of UE 101 and the mobility patterns, which is used for determining (selecting) preferred cellgroup 231. A mobility profile 222 has corresponding information for UE 102. Data sets 220 also tracks the current connections of UE 101 and UE 102, using current cellgroup 212 and current cellgroup 214, respectively. This way, preferred cellgroup logic 210 is able to determine whether UE 101 is already connected to preferred cellgroup 231, or whether a steering action is needed, and similarly for UE 102.

Preferred cellgroup logic 210 determines (selects) preferred cellgroup 231 for UE 102 using cellgroup selection factors 280. Preferred cellgroup 231 is illustrated as having a preferred RAT 241 (e.g., a preferred cellular generation, such as 5G), a preferred CA combination 261 of frequency layers, and a preferred PLMN 410 which may be wireless network 110 as the home network for UE 101.

Preferred CA combination 261 is shown as including a preferred frequency layer 251, which may be a PCell for CA, and another frequency layer 262, which may be an SCell for CA. When UE 101 is instructed to measure radio signal quality of a frequency layer in preferred cellgroup 231, that frequency layer is referred to below (i.e., in relation to later figures) as a frequency layer 271, and may be either preferred frequency layer 251 or frequency layer 262. When frequency layer 271 is determined to be available to UE 101 (i.e., the radio signal quality is sufficient to support a handover or redirection), frequency layer 271 is referred to below as available frequency layer 271a. In examples that do not use CA, UE 101 is steered to only preferred frequency layer 251 on preferred RAT 241 in preferred PLMN.

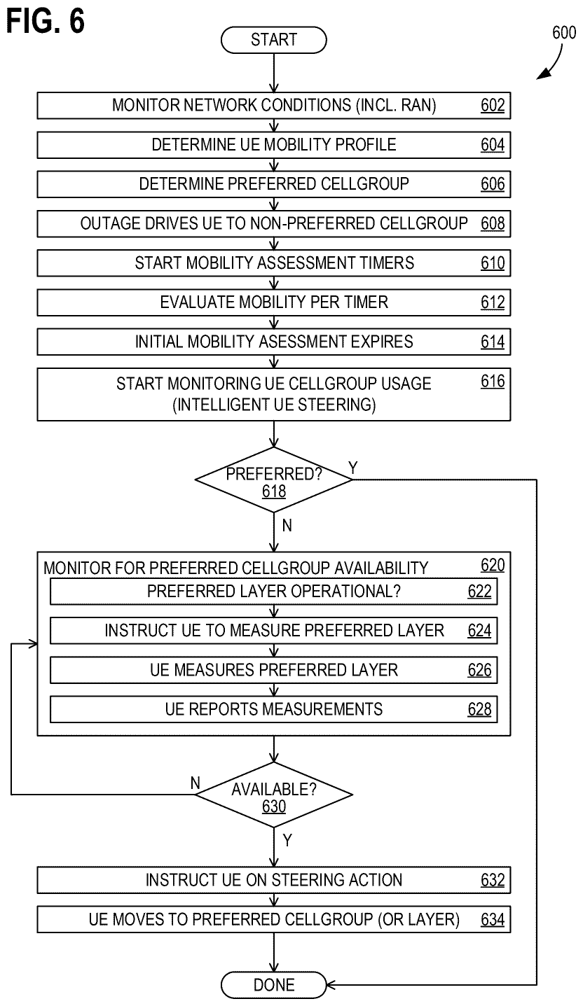

Preferred cellgroup 232 has corresponding information for UE 102, although in the illustrated example, preferred cellgroup 232 has preferred frequency layer 252 that may differ from preferred frequency layer 251. That is, UE 102—even if the same device type as UE 101—may be steered to a different preferred frequency layer, in some scenarios. This is described in relation to FIG. 6. When UE 102 is instructed to measure radio signal quality of a frequency layer in preferred cellgroup 232, that frequency layer is referred to below as a frequency layer 272. When frequency layer 272 is determined to be available to UE 2, frequency layer 272 is referred to below as available frequency layer 272a.

Cellgroup selection factors 280 are used to tailor preferred cellgroup 231 and preferred cellgroup 232 to UE 101 and UE 102, respectively. That is, a preferred cellgroup may be customized for a particular UE. Cellgroup selection factors 280 is shown as having data on network conditions 281, information for UE 101, and information for UE 102. Network conditions 281 includes loading 282 of wireless network 110 (i.e., which network nodes may be close to being overburdened) and RAN operating status 283, such as in the status of base station 111 and other RAN nodes in the vicinity of UE 101. Information for UE 101 includes capability 284 of UE 101 (i.e., supported RATs, frequency layers, and data rates), subscriber data 286 associated with UE 101 (possibly retrieved from subscriber node 116), and mobility profile 288 of UE 101. Information for UE 102 includes capability 285 of UE 102, subscriber data 287 associated with UE 102, and mobility profile 289 of UE 102.

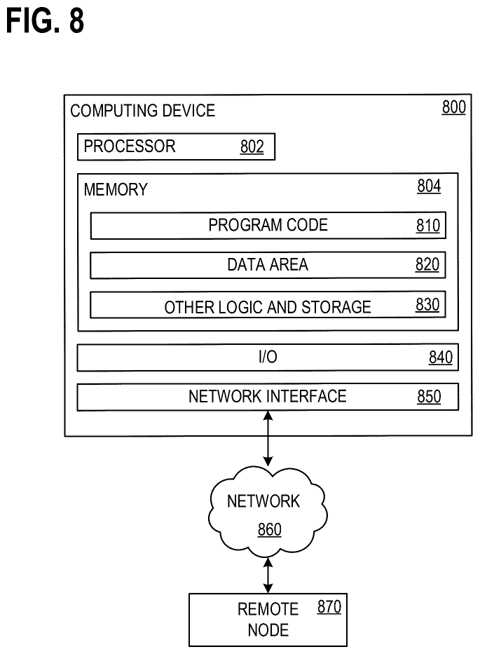

FIG. 3 illustrates a flowchart 300 of exemplary operations associated with architecture 100. In some examples, at least a portion of flowchart 300 may be performed using one or more computing devices 800 of FIG. 8. Flowchart 300 cis described in relation to UE 101; operations for UE 102 are similar. Flowchart 300 commences with UE 101 connecting to current cellgroup 212 in operation 302. Timer 520, which measures the time for initial steering action evaluation (prior to intelligent UE steering commencing) is started in operation 304. Operation 304 also starts timer 522, which is used for controlling the intervals at which UE 101 makes measurements in support of UE 101 evaluating mobility options in operation 306.

Decision operation 308 determines whether UE 101 is already on preferred cellgroup 231. If so, flowchart 300 terminates. Otherwise, decision operation 310 determines whether timer 520 is expired. If timer 520 is not expired, decision operation 312 determines whether timer 522 is expired. When timer 522 does expire, operation 314 restarts timer 522, and flowchart 300 returns to operation 306 for UE 101 to evaluate mobility options again. In some examples, timer 520 is initially set for one hour, and timer 522 is set for 10 minutes. Thus, in such examples, UE 101 evaluates mobility options every 10 minutes for an hour.

At the expiration of timer 520 (initial steering action evaluation), flowchart 300 moves to operation 316 that performs intelligent UE steering, using operations 318-338. Operation 318 starts timer 524, and preferred cellgroup logic 210 determines RAN status in the neighborhood of UE 101 in operation 320. Decision operation 322 determines whether preferred cellgroup 231 is operable. If preferred cellgroup 231 is not operable, decision operation 324 determines whether timer 524 is expired. When timer 524 does expire, operation 326 restarts timer 524, and flowchart 300 returns to decision operation 322.

When preferred cellgroup 231 is operable, flowchart 300 moves to operation 328, which starts timer 524. UE 101 measures radio signal quality of at least some frequency layers in operation 330. In decision operation 332, preferred cellgroup logic 210 determines whether preferred cellgroup 231 is available to UE 101 or suitable for use by UE 101 (which is described in further detail in relation to operations 620-630 of flowchart 600 in FIG. 6). If preferred cellgroup 231 is not available to UE 101 (i.e., not suitable for use), decision operation 334 determines whether timer 526 is expired. When timer 526 does expire, operation 336 restarts timer 526, and flowchart 300 returns to operation 330. When is available to UE 101 or suitable for use by UE 101, operation 338 steers UE 101 to preferred cellgroup 231.

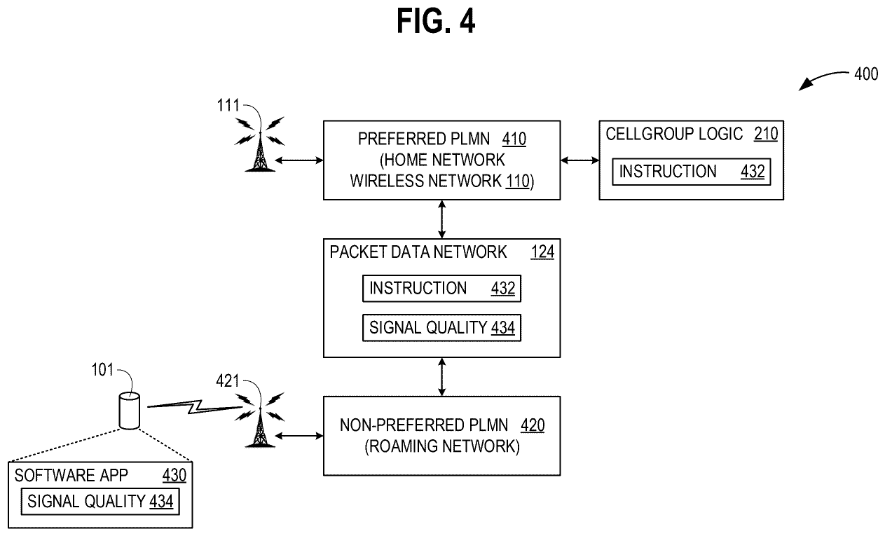

FIG. 4 illustrates a roaming scenario 400 in which wireless network 110, the home network in this example, is preferred PLMN 410. However, UE 101 is roaming and so is instead attached to another PLMN 420. Because preferred cellgroup 231 identifies preferred PLMN 410, UE 101 is not using preferred cellgroup 231 when roaming.

When UE 101 is attached to wireless network 110 (preferred PLMN 410), preferred cellgroup logic 210 is able to use cellular data over wireless network 110 to transmit an instruction 432 for UE 101 to measure preferred cellgroup 231, and UE 101 is able to return the measurement results, received signal quality 434, over cellular data. However, when roaming, UE 101 and preferred cellgroup logic 210 instead communicate over packet data network 124. In order for UE 101 to alert preferred cellgroup logic 210 to its location, and otherwise communicate with preferred cellgroup logic 210, UE 101 has a software application (app) 430.

Thus, when UE 101 is roaming, preferred cellgroup logic 210 transmits instruction 432 through part of wireless network 110 to packet data network 124, which reaches PLMN 420, which then forwards instruction 432 to software application 430 in UE 101 using a RAN 421 of PLMN 420. When UE 101 returns (reports) received signal quality 434, software application 430 transmits received signal quality 434 to PLMN 420, through packet data network 124, to wireless network 110, to reach preferred cellgroup logic 210.

FIG. 5 illustrates a timeline 500 of exemplary events associated with architecture 100. UE 101 moves to current cellgroup 212 at event 501, and timers 520 and 522 are started at event 502. The possibility of a steering action is assessed on multiple lapses of timer 522, at event 503a and event 503b, possibly on 10 minute intervals. When timer 520 lapses at event 504, the initial steering action evaluation is complete. The lapse of timer is a trigger event 505 for preferred cellgroup logic 210 to start monitoring the connection of UE 101. This is the kick-off event 506 of intelligent UE steering (operation 316 of flowchart 300).

Timer 524 is started at event 507, and RAN status is checked at multiple lapses of timer 524, at event 508a and event 508b, possibly on 1 minute intervals. Preferred cellgroup logic 210 identifies preferred cellgroup 231 as being operational, at event 509. Timer 526 is started at event 510, and UE 101 measures received signal quality 434 at multiple lapses of timer 524, at event 511a and event 511b, possibly on 1 minute intervals. Preferred cellgroup logic 210 identifies preferred cellgroup 231 as being available to UE 101 at event 512, and initiates a steering action 514 to steer UE 101 to preferred cellgroup 231. A timeline for UE 102 is similar.

FIG. 6 illustrates a flowchart 600 of exemplary operations associated with examples of architecture 100. In some examples, at least a portion of flowchart 600 may be performed using one or more computing devices 800 of FIG. 8. Flowchart 600 is initially described for UE 101, and modification of flowchart 600 for UE 102 is described next. Flowchart 600 commences with monitoring network conditions 281 of wireless network 110 in operation 602, which remains ongoing. Network conditions 281 of wireless network 110 include loading 282 and RAN operating status 283.

Wireless network 110 determines mobility profile 221 for UE 101 in operation 604, such as, for example, determining that UE 101 is associated with a stationary use when UE 101 comprises an internet access point, such as an FWA device. Based on at least determining mobility profile 221, wireless network 110 determines preferred cellgroup 231 for UE 101 in operation 606. In some examples, preferred cellgroup 231 identifies wireless network 110 as preferred PLMN 410. In some examples, operation 606 includes using two or more of: network conditions 281 of wireless network 110, capability 284 of UE 101, and subscriber data 286 associated with UE 101.

An outage occurs in preferred cellgroup 231, and UE 101 is steered to current cellgroup 212 in as operation 608. Current cellgroup 212 differs from preferred cellgroup 231. Based on the steering action to current cellgroup 212, timer 520 is set for (approximately) 1 hour in operation 610. UE 101 reevaluates mobility options once every 10 minutes or less, using timer 522, in operation 612, until the lapse of timer 520 in operation 614 creates trigger event 505. Trigger event 505 is the lapse of timer 520, which was started upon UE 101 attaching to current cellgroup 212 in operation 608.

Preferred cellgroup logic 210 start monitoring whether UE 101 is using preferred cellgroup 231 in operation 616, upon trigger event 505. Decision operation 618 determines whether UE 101 using preferred cellgroup 231. If so, flowchart 600 terminates. Otherwise, operation 620 monitors whether frequency layer 271 in preferred cellgroup 231 is available for steering action 514 of UE 101. Steering action 514 is a handover, when UE 101 is in connected mode, or a redirection, when UE 101 is in idle mode. Steering action 514 moves UE 101 to the available frequency layer 271a of preferred cellgroup 231. When CA is used, preferred cellgroup 231 includes preferred CA combination 261 of multiple frequency layers, and available frequency layer 271a may be the PCell or the SCell of preferred CA combination 261 (which has multiple frequency layers).

Operation 620 is performed using operations 622-628. Operation 622 monitors whether frequency layer 271 in preferred cellgroup 231 is operational, using RAN operating status 283. Based on at least determining that the frequency layer 271 in preferred cellgroup 231 is operational, preferred cellgroup logic 210 of wireless network 110 instructs UE 101 to measure received signal quality 434 of frequency layer 271. In some scenarios, such as when UE 101 is roaming, upon receiving instruction 432 to measure received signal quality 434, UE 101 is roaming and so is attached to PLMN 420, rather than attached to preferred PLMN 410. In such scenarios, wireless network 110 and the UE communicate instruction 432 and received signal quality 434 using software application 430 on UE 101. In operation 626, UE 101 measures received signal quality 434 according to instruction 432, and reports received signal quality 434 to wireless network 110 in operation 628.

Decision operation 630 determines whether frequency layer 271 is available to UE 101, using the results of operation 620. For example, this involves determining whether received signal quality 434 is sufficient to support UE 101 attaching to preferred cellgroup 231. If not, flowchart 600 returns to operation 620. Otherwise, based on at least UE 101 not using preferred cellgroup 231 and based on at least the available frequency layer 271a 272a of preferred cellgroup 231 becoming available, and without any steering action request by UE 101, in operation 632, wireless network 110 (preferred cellgroup logic 210) instructs UE 101 to perform steering action 514. UE 101 moves to preferred cellgroup 231, or at least available frequency layer 271a of preferred cellgroup 231, in operation 634. This may be the PCell of preferred cellgroup 231, if preferred cellgroup 231 includes carrier aggregation.

Applying flowchart 600 to UE 102 is a straightforward substitution of UE 102 for UE 101, preferred cellgroup 232 for the first cellgroup, and other corresponding element substitutions. For example, in operation 604, wireless network 110 determines mobility profile 222 for UE 102. In operation 606, based on at least determining mobility profile 222 for UE 102, wireless network 110 determines preferred cellgroup 232 for UE 102. In some examples, preferred cellgroup 232 has preferred frequency layer 252 that is not in preferred cellgroup 231. This may be due to capability 285 of UE 102 differing from capability 284 of UE 101, mobility profile 222 differing from mobility profile 221, UE 102 and UE 101 having stationary use at different distances from serving cells (i.e., UE 102 needs the lower frequency band for longer range), and/or network loading differences between serving cells of UE 102 and UE 101.

In this application to UE 102, operation 616 monitors whether UE 102 is using preferred cellgroup 232, and operation 620 monitors whether frequency layer 272 in preferred cellgroup 232 is available for a steering action of UE 102. In operation 632, based on at least UE 102 not using preferred cellgroup 232 and based on at least available frequency layer 272a of preferred cellgroup 232 becoming available, and without any steering action request by UE 102, wireless network 110 instructs UE 102 to perform a steering action. UE 102 moves to preferred cellgroup 232, or at least the available frequency layer 272a of preferred cellgroup 232, in operation 634.

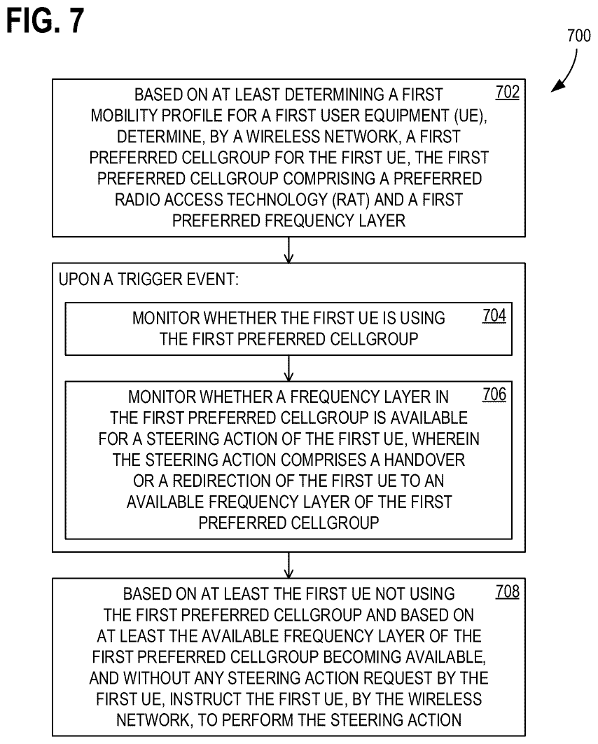

FIG. 7 illustrates a flowchart 700 of exemplary operations associated with architecture 100. In some examples, at least a portion of flowchart 700 may be performed using one or more computing devices 800 of FIG. 8. Flowchart 700 commences with operation 702, which includes, based on at least determining a first mobility profile for a first UE, determining, by a wireless network, a first preferred cellgroup for the first UE, the first preferred cellgroup comprising a preferred RAT and a first preferred frequency layer.

Operations 704 and 706 are based on at least a trigger event. Operation 704 includes monitoring whether the first UE is using the first preferred cellgroup. Operation 706 includes monitoring whether a frequency layer in the first preferred cellgroup is available for a steering action of the first UE, wherein the steering action comprises a handover or a redirection of the first UE to an available frequency layer of the first preferred cellgroup. Operation 708 includes, based on at least the first UE not using the first preferred cellgroup and based on at least the available frequency layer of the first preferred cellgroup becoming available, and without any steering action request by the first UE, instructing the first UE, by the wireless network, to perform the steering action.

FIG. 8 illustrates a block diagram of computing device 800 that may be used as any component described herein that may require computational or storage capacity. Computing device 800 has at least a processor 802 and a memory 804 that holds program code 810, data area 820, and other logic and storage 830. Memory 804 is any device allowing information, such as computer executable instructions and/or other data, to be stored and retrieved. For example, memory 804 may include one or more random access memory (RAM) modules, flash memory modules, hard disks, solid-state disks, persistent memory devices, and/or optical disks. Program code 810 comprises computer executable instructions and computer executable components including instructions used to perform operations described herein. Data area 820 holds data used to perform operations described herein. Memory 804 also includes other logic and storage 830 that performs or facilitates other functions disclosed herein or otherwise required of computing device 800. An input/output (I/O) component 840 facilitates receiving input from users and other devices and generating displays for users and outputs for other devices. A network interface 850 permits communication over external network 860 with a remote node 870, which may represent another implementation of computing device 800. For example, a remote node 870 may represent another of the above-noted nodes within architecture 100.

### ADDITIONAL EXAMPLES

An example system comprises: a processor; and a computer-readable medium storing instructions that are operative upon execution by the processor to: based on at least determining a first mobility profile for a first UE, determine, by a wireless network, a first preferred cellgroup for the first UE, the first preferred cellgroup comprising a preferred RAT and a first preferred frequency layer; upon a trigger event: monitor whether the first UE is using the first preferred cellgroup; and monitor whether a frequency layer in the first preferred cellgroup is available for a steering action of the first UE, wherein the steering action comprises a handover or a redirection of the first UE to an available frequency layer of the first preferred cellgroup; and based on at least the first UE not using the first preferred cellgroup and based on at least the available frequency layer of the first preferred cellgroup becoming available, and without any steering action request by the first UE, instruct the first UE, by the wireless network, to perform the steering action.

An example method of wireless communication comprises: based on at least determining a first mobility profile for a first UE, determining, by a wireless network, a first preferred cellgroup for the first UE, the first preferred cellgroup comprising a preferred RAT and a first preferred frequency layer; upon a trigger event: monitoring whether the first UE is using the first preferred cellgroup; and monitoring whether a frequency layer in the first preferred cellgroup is available for a steering action of the first UE, wherein the steering action comprises a handover or a redirection of the first UE to an available frequency layer of the first preferred cellgroup; and based on at least the first UE not using the first preferred cellgroup and based on at least the available frequency layer of the first preferred cellgroup becoming available, and without any steering action request by the first UE, instructing the first UE, by the wireless network, to perform the steering action.

One or more example computer storage devices has computer-executable instructions stored thereon, which, upon execution by a computer, cause the computer to perform operations comprising: based on at least determining a first mobility profile for a first UE, determining, by a wireless network, a first preferred cellgroup for the first UE, the first preferred cellgroup comprising a preferred RAT and a first preferred frequency layer; upon a trigger event: monitoring whether the first UE is using the first preferred cellgroup; and monitoring whether a frequency layer in the first preferred cellgroup is available for a steering action of the first UE, wherein the steering action comprises a handover or a redirection of the first UE to an available frequency layer of the first preferred cellgroup; and based on at least the first UE not using the first preferred cellgroup and based on at least the available frequency layer of the first preferred cellgroup becoming available, and without any steering action request by the first UE, instructing the first UE, by the wireless network, to perform the steering action.

Alternatively, or in addition to the other examples described herein, examples include any combination of the following:
the wireless network comprises a cellular network;
determining the first mobility profile for the first UE comprises determining that the first UE is associated with a stationary use;
the first UE comprises an internet access point;
monitoring whether a frequency layer in the first preferred cellgroup is available comprises determining, by the wireless network, whether a frequency layer in the first preferred cellgroup is operational;
monitoring whether a frequency layer in the first preferred cellgroup is available comprises, based on at least determining that a frequency layer in the first preferred cellgroup is operational, instructing, by the wireless network, the first UE to measure a received signal quality of a frequency layer in the first preferred cellgroup;
monitoring whether a frequency layer in the first preferred cellgroup is available comprises measuring, by the first UE, the received signal quality according to the instruction; monitoring whether a frequency layer in the first preferred cellgroup is available comprises reporting, by the first UE, to the wireless network, the received signal quality;
the first preferred cellgroup further identifies the wireless network as a preferred PLMN;
upon receiving the instruction to measure a received signal quality of a frequency layer in the first preferred cellgroup, the first UE is attached to a second PLMN, not the preferred PLMN;
the wireless network and the UE communicate the instruction to measure a received signal quality of a frequency layer in the first preferred cellgroup and the received signal quality using a software application on the first UE;
determining, by the wireless network, the first mobility profile for the first UE;
determining, by the wireless network, a second mobility profile for a second UE;
based on at least determining the second mobility profile for the second UE, determining, by the wireless network, a second preferred cellgroup for the second UE;
the second preferred cellgroup comprises a second preferred frequency layer not in the first preferred cellgroup;
monitoring whether the second UE is using the second preferred cellgroup;
the first preferred cellgroup further comprises a preferred CA combination of multiple frequency layers;
monitoring network conditions of the wireless network;
the first preferred cellgroup is based on at least two factors selected from the list consisting of: the network conditions of the wireless network, capability of the first UE, and subscriber data associated with the first UE;
the trigger event comprises a lapse of a timer started upon the first UE attaching to its current cellgroup;
prior to the lapse of the timer, the first UE reevaluates mobility options once every 10 minutes or less;
the second UE comprises an internet access point;
the first UE and the second UE each comprises an FWA device;
the stationary use includes facility internet access;
the preferred RAT comprises a preferred cellular generation;
the timer is set for (approximately) 1 hour;
the available frequency layer of the first preferred cellgroup is the CA PCell;
the steering action comprises a handover when the first UE is in connected mode;
the steering action comprises a redirection when the first UE is in idle mode;
the wireless network, as the preferred PLMN, is a home network;
the second PLMN is a roaming network;
the first UE is roaming when attached to the second PLMN;
the second preferred cellgroup comprises a second preferred frequency layer not in the first preferred cellgroup based on at least the second mobility profile differing from the first mobility profile;
the second preferred cellgroup comprises a second preferred frequency layer not in the first preferred cellgroup based on at least the second UE and the first UE having stationary use at different distances from serving cells;
the second preferred cellgroup comprises a second preferred frequency layer not in the first preferred cellgroup based on at least network loading differences between serving cells of the second UE and the first UE;
monitoring whether a frequency layer in the second preferred cellgroup is available for a steering action of the second UE, wherein the steering action of the second UE comprises a handover or a redirection of the second UE to an available frequency layer of the second preferred cellgroup;
based on at least the second UE not using the second preferred cellgroup and based on at least the available frequency layer of the second preferred cellgroup becoming available, and without any steering action request by the second UE, instructing the second UE, by the wireless network, to perform the steering action of the second UE;
determining a preferred cellgroup for a UE comprises determining network conditions, capability of the UE, subscriber data associated with the UE, and a mobility profile of the UE; and
the network conditions of the wireless network include loading and RAN operating status.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method of wireless communication, the method comprising:
based on at least determining a first mobility profile for a first user equipment (UE), determining, by a wireless network, a first preferred cellgroup for the first UE, the first preferred cellgroup comprising a preferred radio access technology (RAT) and a first preferred frequency layer;
upon a trigger event:
monitoring whether the first UE is using the first preferred cellgroup; and
monitoring whether a frequency layer in the first preferred cellgroup is available for a steering action of the first UE, wherein the steering action comprises a handover or a redirection of the first UE to an available frequency layer of the first preferred cellgroup; and
based on at least the first UE not using the first preferred cellgroup and based on at least the available frequency layer of the first preferred cellgroup becoming available, and without any steering action request by the first UE, instructing the first UE, by the wireless network, to perform the steering action.

2. The method of claim 1, wherein determining the first mobility profile for the first UE comprises determining that the first UE is associated with a stationary use, and wherein the first UE comprises an internet access point.

3. The method of claim 1, wherein monitoring whether a frequency layer in the first preferred cellgroup is available comprises:
determining, by the wireless network, whether a frequency layer in the first preferred cellgroup is operational;
based on at least determining that a frequency layer in the first preferred cellgroup is operational, instructing, by the wireless network, the first UE to measure a received signal quality of a frequency layer in the first preferred cellgroup;
measuring, by the first UE, the received signal quality according to the instruction; and
reporting, by the first UE, to the wireless network, the received signal quality.

4. The method of claim 1,
wherein the first preferred cellgroup further identifies the wireless network as a preferred public land mobile network (PLMN);
wherein upon receiving the instruction to measure a received signal quality of a frequency layer in the first preferred cellgroup, the first UE is attached to a second PLMN, not the preferred PLMN; and
wherein the wireless network and the UE communicate the instruction to measure a received signal quality of a frequency layer in the first preferred cellgroup and the received signal quality using a software application (app) on the first UE.

5. The method of claim 1, further comprising:
determining, by the wireless network, the first mobility profile for the first UE;
determining, by the wireless network, a second mobility profile for a second UE;
based on at least determining the second mobility profile for the second UE, determining, by the wireless network, a second preferred cellgroup for the second UE, the second preferred cellgroup comprising a second preferred frequency layer not in the first preferred cellgroup; and
monitoring whether the second UE is using the second preferred cellgroup.

6. The method of claim 1, wherein the first preferred cellgroup further comprises a preferred carrier aggregation (CA) combination of multiple frequency layers.

7. The method of claim 1, further comprising:
monitoring network conditions of the wireless network, wherein the first preferred cellgroup is based on at least two factors selected from the list consisting of:
the network conditions of the wireless network, capability of the first UE, and subscriber data associated with the first UE.

8. The method of claim 1, wherein the trigger event comprises a lapse of a timer started upon the first UE attaching to its current cellgroup, wherein prior to the lapse of the timer, the first UE reevaluates mobility options once every 10 minutes or less.

9. A system comprising:
a processor; and
a computer-readable medium storing instructions that are operative upon execution by the processor to:
based on at least determining a first mobility profile for a first user equipment (UE), determine, by a wireless network, a first preferred cellgroup for the first UE, the first preferred cellgroup comprising a preferred radio access technology (RAT) and a first preferred frequency layer;
upon a trigger event:
monitor whether the first UE is using the first preferred cellgroup; and
monitor whether a frequency layer in the first preferred cellgroup is available for a steering action of the first UE, wherein the steering action comprises a handover or a redirection of the first UE to an available frequency layer of the first preferred cellgroup; and
based on at least the first UE not using the first preferred cellgroup and based on at least the available frequency layer of the first preferred cellgroup becoming available, and without any steering action request by the first UE, instruct the first UE, by the wireless network, to perform the steering action.

10. The system of claim 9, wherein determining the first mobility profile for the first UE comprises determining that the first UE is associated with a stationary use, and wherein the first UE comprises an internet access point.

11. The system of claim 9, wherein monitoring whether a frequency layer in the first preferred cellgroup is available comprises:
determining, by the wireless network, whether a frequency layer in the first preferred cellgroup is operational;
based on at least determining that a frequency layer in the first preferred cellgroup is operational, instructing, by the wireless network, the first UE to measure a received signal quality of a frequency layer in the first preferred cellgroup;
measuring, by the first UE, the received signal quality according to the instruction; and
reporting, by the first UE, to the wireless network, the received signal quality.

12. The system of claim 9,
wherein the first preferred cellgroup further identifies the wireless network as a preferred public land mobile network (PLMN);
wherein upon receiving the instruction to measure a received signal quality of a frequency layer in the first preferred cellgroup, the first UE is attached to a second PLMN, not the preferred PLMN; and
wherein the wireless network and the UE communicate the instruction to measure a received signal quality of a frequency layer in the first preferred cellgroup and the received signal quality using a software application (app) on the first UE.

13. The system of claim 9, wherein the instructions are further operative to:
determine, by the wireless network, the first mobility profile for the first UE;
determine, by the wireless network, a second mobility profile for a second UE;
based on at least determining the second mobility profile for the second UE, determine, by the wireless network, a second preferred cellgroup for the second UE, the second preferred cellgroup comprising a second preferred frequency layer not in the first preferred cellgroup; and
monitor whether the second UE is using the second preferred cellgroup.

14. The system of claim 9, wherein the first preferred cellgroup further comprises a preferred carrier aggregation (CA) combination of multiple frequency layers, and wherein the instructions are further operative to:
monitor network conditions of the wireless network, wherein the first preferred cellgroup is based on at least two factors selected from the list consisting of:
the network conditions of the wireless network, capability of the first UE, and subscriber data associated with the first UE.

15. One or more computer storage devices having computer-executable instructions stored thereon, which, upon execution by a computer, cause the computer to perform operations comprising:
based on at least determining a first mobility profile for a first user equipment (UE), determining, by a wireless network, a first preferred cellgroup for the first UE, the first preferred cellgroup comprising a preferred radio access technology (RAT) and a first preferred frequency layer;
upon a trigger event:
monitoring whether the first UE is using the first preferred cellgroup; and
monitoring whether a frequency layer in the first preferred cellgroup is available for a steering action of the first UE, wherein the steering action comprises a handover or a redirection of the first UE to an available frequency layer of the first preferred cellgroup; and
based on at least the first UE not using the first preferred cellgroup and based on at least the available frequency layer of the first preferred cellgroup becoming available, and without any steering action request by the first UE, instructing the first UE, by the wireless network, to perform the steering action.

16. The one or more computer storage devices of claim 15, wherein determining the first mobility profile for the first UE comprises determining that the first UE is associated with a stationary use, and wherein the first UE comprises an internet access point.

17. The one or more computer storage devices of claim 15, wherein monitoring whether a frequency layer in the first preferred cellgroup is available comprises:
determining, by the wireless network, whether a frequency layer in the first preferred cellgroup is operational;
based on at least determining that a frequency layer in the first preferred cellgroup is operational, instructing, by the wireless network, the first UE to measure a received signal quality of a frequency layer in the first preferred cellgroup;
measuring, by the first UE, the received signal quality according to the instruction; and
reporting, by the first UE, to the wireless network, the received signal quality.

18. The one or more computer storage devices of claim 15,
wherein the first preferred cellgroup further identifies the wireless network as a preferred public land mobile network (PLMN);
wherein upon receiving the instruction to measure a received signal quality of a frequency layer in the first preferred cellgroup, the first UE is attached to a second PLMN, not the preferred PLMN; and
wherein the wireless network and the UE communicate the instruction to measure a received signal quality of a frequency layer in the first preferred cellgroup and the received signal quality using a software application (app) on the first UE.

19. The one or more computer storage devices of claim 15, wherein the operations further comprise:
determining, by the wireless network, the first mobility profile for the first UE;
determining, by the wireless network, a second mobility profile for a second UE;
based on at least determining the second mobility profile for the second UE, determining, by the wireless network, a second preferred cellgroup for the second UE, the second preferred cellgroup comprising a second preferred frequency layer not in the first preferred cellgroup; and
monitoring whether the second UE is using the second preferred cellgroup.

20. The one or more computer storage devices of claim 15, wherein the first preferred cellgroup further comprises a preferred carrier aggregation (CA) combination of multiple frequency layers.
